(19) United States
(12) Patent Application Publication
(10) Pub. No.: US 2006/0265504 A1
(43) Pub. Date: Nov. 23, 2006

(54) Universal convergence border gateway

(75) Inventors: Pouya Taaghol, San Jose, CA (US); William Osmond Howe, Los Altos, CA (US); Nishi Kant, San Jose, CA (US); Naveen Dhar, San Jose, CA (US)

Correspondence Address: GROOVER & HOLMES, BOX 802889, DALLAS, TX, 75380-2889, US

(73) Assignee: Azaire Networks Inc., Santa Clara, CA (US)

(21) Appl. No.: 11/233,936

(22) Filed: Sep. 23, 2005

Related U.S. Application Data
(60) Provisional application No. 60/682,226, filed on May 18, 2005.
(60) Provisional application No. 60/682,227, filed on May 18, 2005.
(60) Provisional application No. 60/698,055, filed on Jul. 11, 2005.

(51) Int. Cl. G06F 15/16

(52) U.S. Cl. 709/227

(57) ABSTRACT

A services gateway, which links client access by any technology to multiple service nodes, even if the client access technology is not directly compatible with the service node. The universal convergence border gateway (UCBG) utilizes the IP layer as a harmonizing layer to decouple standard services from their normally-associated access technologies. This is particularly advantageous with multifunction client devices because the best available wireless access technology can be used independently of the type of service being accessed. The UCBG uses a single encryption scheme to multiplex the traffic for various services with different characteristics into multiple data flows. The UCBG uses a single encryption scheme to converge the data flows to the client using a single control path without losing each traffic's characteristics such as QoS. The gateway also demultiplexes the converged traffic that it receives from the client in order for the data to reach the appropriate service node.

### CROSS-REFERENCE TO RELATED APPLICATIONS

This application claims priority from U.S. Provisional Application 60/682,226 filed May 18, 2005; 60/682,227 filed May 18, 2005; and 60/698,055 filed Jul. 11, 2005, all of which are hereby incorporated by reference.

### BACKGROUND AND SUMMARY OF THE INVENTION

1. Field of the Invention

The present inventions relate generally to wireless services and, more particularly, to methods and systems for providing converged delivery of wireless services.

2. Background

Introduction of New Generation Mobile Cellular Technologies

New generations of mobile cellular technologies traditionally have been introduced with new radio interfaces and upgrades to legacy core networks. Prior to commercial introduction, the new radio air-interfaces are required to be integrated to the extent that they provide a seamless transition to the legacy system, allow the reuse of existing OSS, and enable existing services. This rigorous standardization process has resulted in delayed adoption or non-adoption of new radio technologies.

Also, unlicensed radio technologies are increasingly being accepted by mobile cellular operators as inexpensive alternative access networks. Ultimately, mobile operators would like to offer identical services over any access technologies including the unlicensed radio.

Accordingly, there is a need for a wireless services gateway that enables seamless deployment of new access technologies by reusing existing service delivery platforms and OSS. This would allow new services to be introduced easily and independently of the access network.

Accessing Multiple Services Across An IP Network

Because current convergence technologies only converge access technologies and not services, they still require the user equipment to handle a separate security or service gateway for each service accessed. There is no focal point between these services, and this can cause problems with service delivery and CPU processing.

Accordingly, there is also a need for a wireless services gateway that allows clients to access all packet network services offered by a core network without requiring the user equipment to handle a separate security or service gateway for each service accessed, thereby reducing problems with service delivery and CPU processing.

Universal Convergence Border Gateway (UCBG)

The present application discloses a services gateway, which links client access by any technology to multiple service nodes, even if the client access technology is not directly compatible with the service node. The universal convergence border gateway (UCBG) utilizes the IP layer as a harmonizing layer to decouple standard services from the constraints of their normally-associated access technologies. This is particularly advantageous with multifunction client devices because the best available wireless access technology can be used independently of the type of service being accessed.

The UCBG multiplexes the traffic from various services and converges the data flows into a single primary security association to send it to the user client. Preferably, the user equipment can connect with multiple different types of data flows. The gateway also demultiplexes the converged traffic that it receives from the user client in order to route the traffic to the appropriate services.

In preferred embodiments, a single encryption scheme is used to secure the multiple data flows having different characteristics for multiple different services. Therefore, independent multiple transfer channels with different encryption schemes are not required to be maintained by the user client. The UCBG is able to maintain the different traffic characteristics of the various data flows while keeping the single encryption scheme.

The UCBG also enables mobile operators and service providers to offer identical services and integrated billing/OSS over any licensed or unlicensed access technologies by acting as an anchor point for multiple accesses and services. Among the services provided, a corporate service may require the username/password to grant the access to the client. When the client is accessing a corporate service through access mechanisms other than GPRS, there should be a mechanism to send the username/password securely over an untrusted access network. The proposed UCBG provides such a mechanism by utilizing the Configuration payload of IKE message to deliver the username/password information in the IKE SA. Therefore, the information is protected, and the client can access the corporate domain through a secure VPN.

A few examples of the advantages of the disclosed UCBG include:
integrated billing;
seamless mobility between different access technologies;
access to all services offered by GPRS/UMTS/EDGE packet networks via existing GGSN;
access to all services offered by cdma2000 cellular packet networks via existing PDSN;
access to all services offered by GPRS/UMTS/EDGE packet networks via existing GGSN and cdma2000 cellular packet networks via existing PDSN over any access technology that enables IP connectivity between the user client and the UCBG;
reuse of existing billing and OSS of mobile cellular networks;
enforcement of routing and security policies per end-user traffic;
one or multiple data flows towards the user client accessing a bundle of services is provided based on requested services, end-user capabilities, and UCBG conditions (e.g. load); and
maintaining the different traffic characteristics of multiple data flows towards the user client accessing a bundle of services while using a single encryption scheme for all of the data flows.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 is an illustration of a prior art network architecture.

FIG. 2 is a message flow/signaling chart for a prior art network architecture.

FIG. 3 shows a sample embodiment of a network architecture incorporating a universal convergence border gateway.

FIG. 4 is a message flow/signaling chart of a sample embodiment of a network architecture incorporating a universal convergence border gateway.

FIG. 5 shows a sample embodiment of a universal convergence border gateway used as an access-independent services gateway.

FIG. 6 shows another sample embodiment of a universal convergence border gateway and dual-mode user equipment.

### DETAILED DESCRIPTION OF THE PREFERRED EMBODIMENTS

The numerous innovative teachings of the present application will be described with particular reference to the presently preferred embodiment (by way of example, and not of limitation).

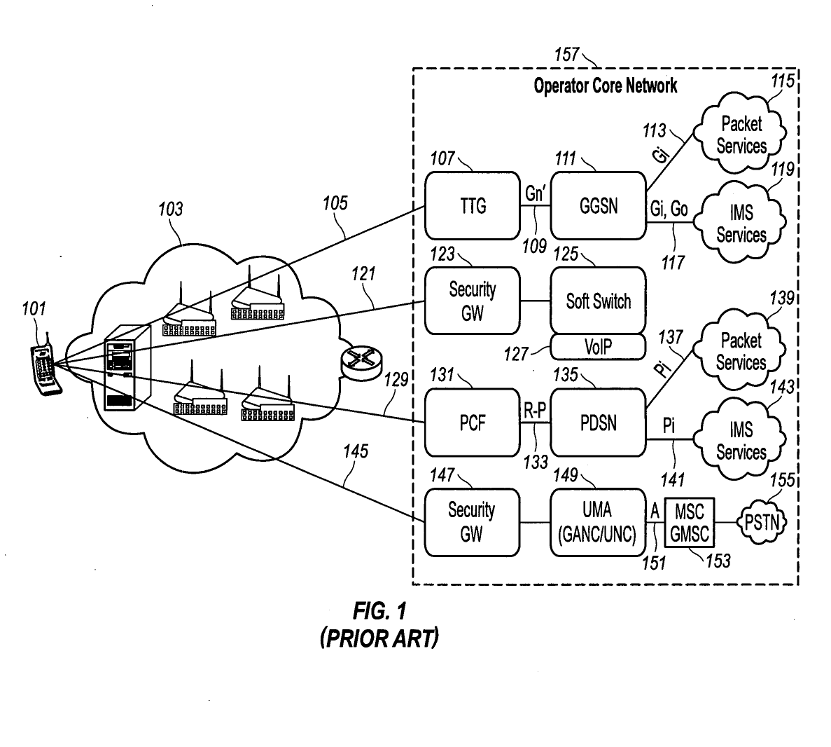

FIG. 1 is an illustration of a prior art network architecture.

In this illustration, user equipment 101 uses access network 103 to access the services offered by core network 157. For each service accessed by user equipment 101, a separate secure connection, such as 105, 121, 129, or 145, must be created.

For example, in order to access GPRS services through WLAN, an IKE/IPsec SA 105 is established between user equipment 101 and TTG 107. GTP tunnel 109 is then established using a subset of the Gn reference point, Gn′. Link 117 between IMS services 119 and GGSN 111 (via a Gi or Go interface) enables user equipment 101 to access IMS services 119. User equipment 101 can also access packet services 115 through link 113 via a Gi interface.

In order to access VoIP services, another secure connection 121 is established between user equipment 101 and security gateway 123. Once secure connection 121 is established, user equipment 101 is now able to access VoIP services 127 via softswitch 125.

To access cdma2000-based services, another secure connection, for example IKE/IPsec SA 129, is established between user equipment 101 and PCF 131. An R-P tunnel 133 is then created between PCF 131 and PDSN 135 (via an R-P interface). Link 141 between IMS services 143 and PDSN 135 (via interface Pi) enables user equipment 101 to access IMS services 143. User equipment 101 can also access packet services 139 through link 137 via a Pi interface.

To access PSTN 155 using unlicensed mobile access 149, yet another secure connection 145 needs to be established between user equipment 101 and security gateway 147. UMA network controller 149 connects user equipment 101 to PSTN 155 through link 151 between UMA 149 and MSC/GMSC 153 (via interface A).

Accordingly, for each service node accessed by user equipment 101, a separate secure connection must be maintained by user equipment 101. As a result, the user can only access the service through the coupled access technology.

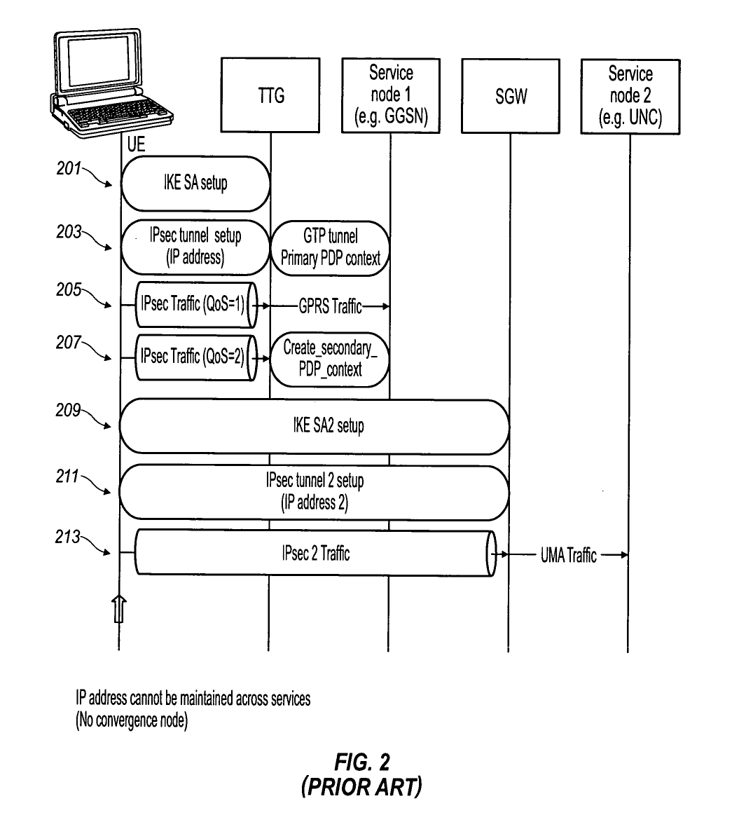

FIG. 2 is a message flow/signaling chart of a prior art network architecture.

In this example, the UE establishes an IKE SA with the TTG for GPRS traffic (message flow 201). An IPSec tunnel is then setup between the UE and the TTG, and a primary GTP tunnel is established between the TTG and the GGSN (message flow 203). When there is GPRS traffic with QoS1, i.e. the requested QoS upon IPsec tunnel and primary GTP tunnel establishment, it is carried inside this IPSec tunnel, and the TTG sends the traffic to the GGSN (message flow 205). When there is GPRS traffic with different QoS, for example QoS2, there is currently no specified way for the UE and the TTG to differentiate or separate the traffic, so the traffic is mixed in one IPSec tunnel (message flow 207). This could cause the quality issue since traffic with very different characteristics (for example voice and web browsing) are treated the same way. The TTG can differentiate the traffic toward the GGSN using GPRS mechanism. The traffic may then be carried in a separate GTP tunnel between the TTG and the GGSN. When another service through another service node, e.g. UMA through UNC, is requested, another secure tunnel should be established toward this node. To achieve this, a new IKE SA is established between the UE and the SGW (security gateway) (message flow 209). The second IPsec tunnel is then setup using this new IKE SA between the UE and the SGW (message flow 211). The UMA traffic is carried inside this second IPSec tunnel, and SGW delivers the traffic accordingly to the UNC (message flow 213). There is no relationship between these two services.

Converged Delivery of Services

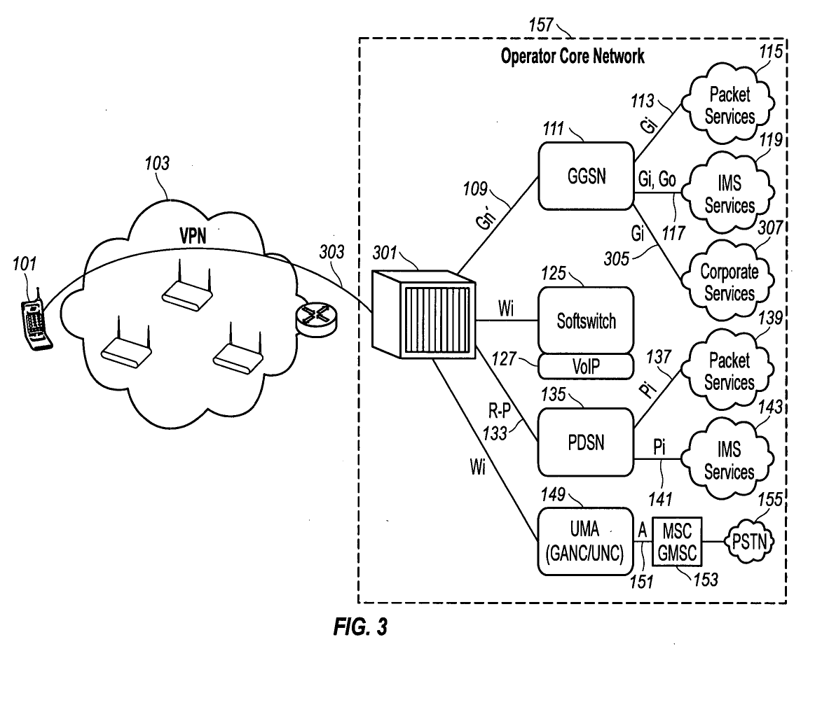

FIG. 3 shows a sample embodiment of a network architecture incorporating a universal convergence border gateway.

In this figure, universal convergence border gateway (UCBG) 301 is the core component of the services convergence. UCBG 301 establishes a secure connection 303 to user equipment 101. Secure connection 303 ensures the integrity and security of data transfer over wireless and distrusted access networks, such as WLAN 103 (especially in roaming cases). A secure connection is established only after successful authentication and authorization procedures based on the client's requested service and current subscription have been completed. UCBG 301 may communicate with an external server for signaling, control, and accounting purposes.

In contrast to the architecture shown in FIG. 1, the architecture shown in FIG. 3 does not require the user equipment to support a separate secure connection for each service accessed since the UCBG establishes the primary security association with the user client and uses this SA for all the traffic for multiple different services. The user equipment no longer needs to maintain secure connections 105, 121, 129, and 145. The UCBG replaces Security gateways 107 and 147, TTG 107, and PCF 131. The services are no longer bound to their normally-associated access technologies and become universally available through different access networks.

FIG. 3 also shows a few examples of applications that can be converged using a universal convergence border gateway:
IMS Application: IMS is an IP-based infrastructure for secure delivery of multimedia services over cellular technologies. IMS services use the PS domain as the transport layer, and hence they can be provided from the GGSN or PDSN platform. The link between IMS and the GGSN (via Gi or Go interface) or the PDSN (via Pi interface) enables exchange of QoS and policy parameters, as well as charging correlation identities. UCBG 301 enables IMS services 119 and 143 over any access technology (deployed in TTG/tunnel-switching mode or PCF) by reusing GGSN 111 or PDSN 135 platforms and all associated configurations.
VoIP Applications: UCBG 301 can terminate a secure connection from the user equipment over the WLAN access technology. Once a secure, authenticated session with the user equipment is established, the operator's softswitch 125 with VoIP infrastructure 127 can deliver SIP-based VoIP calls to the user equipment over alternative access technologies. This enables the operator to extend their current 2G/3G footprint to deliver WLAN access to reduce the overall cost of deployment.
UMA Application: The UMA solution emulates a 2G BSC function (GANC/UNC 149) by a connection 151 from one side to existing 2G MSC 153 (via A interface) and a connection from another side to the user equipment via VPN/IP. In order to smoothly integrate UMA with Release 6 Interworking architecture, it is best to minimize overlapping functionalities and reuse existing functions already available in Release 6 I-WLAN systems. UCBG 301 can provide a secure, authenticated, and authorized bearer for UMA services.
   Using a Single Primary Security Association to Differentiate and Isolate Traffics with Different Characteristics and QoS Requirements

In various embodiments, UCBG 301 enables mobile operators and service providers to offer identical services and integrated billing/OSS over any licensed or unlicensed access technologies by decoupling the services from their normally-associated access technologies.

In one embodiment, once the primary security association, e.g. IKE SA, is established, several child or IPSec SAs are created to carry service traffic with different characteristics, such as QoS or “access characteristics”, e.g. corporate intranet. However, these IPSec SAs are controlled by the one primary SA that was used to create the IPSec SAs. This makes it possible to differentiate and isolate traffics with different characteristics and QoS requirements. Accordingly, traffic characteristics are not lost while keeping the single encryption scheme.

In one embodiment, the IKE is used as the primary SA between the UCBG and user client, and the IKE's Configuration payload is used to indicate the different services and/or service nodes when creating an IPSec SA toward UCBG 301. UCBG 301 stores these characteristics with the IPSec SPI, and when the IPSec traffic with specific SPI flows in, it determines which service and/or service node should be used for this traffic. Therefore, there is no need for complex logic to distinguish the traffic at UCBG 301, and UCBG 301 can simply forward the traffic to the appropriate service node using the IPSec SPI value.

Among the services provided, corporate services 307 may require the username/password before granting access to the client. When the client is accessing corporate services 307 through link 305 (via Gi interface) using access mechanisms other than GPRS, there should be a mechanism available to send the username/password securely over an access network, especially an untrusted access network. The presently disclosed UCBG provides a security mechanism utilizing the Configuration payload of the IKE message. The username/password information is delivered in the IKE SA, and the UCBG forwards this information to GGSN according to standard GPRS process. Accordingly, the information is protected, and the client can access the corporate domain through a secure VPN.

Since the username/password is sensitive information, this information is provided only after the user and the UCBG are mutually authenticated and the secure IKE SA is established. Using this method, the user can access corporate services 307 through a secure IPSec tunnel.

A few examples of the advantages of this embodiment include:
having one or more IPSec SA's towards the user equipment accessing a bundle of services. The decision for using a single or multiple tunnels towards the end-user is based on the dynamic combination of requested services, end-user capabilities, and UCBG conditions (e.g. load);
deleting the tunnels, individually or together, according to the service availability, user preference, and/or service category;
delivering the services and their characteristics to the UCBG using the primary SA (IKE SA)'s payload;
once the information is stored, identifying the services and their characteristics simply using the IPSec SPI;
transferring the username and password information to the application access server for application level authentication over secure IPSec tunnel;
using the IKE Configuration payload to carry the application or domain username and password information;
allowing the client to provide the application username and password information to the UCBG over the secure transfer channel; and
allowing the client to provide the application username and password in IKE Configuration payload based on the selected APN.

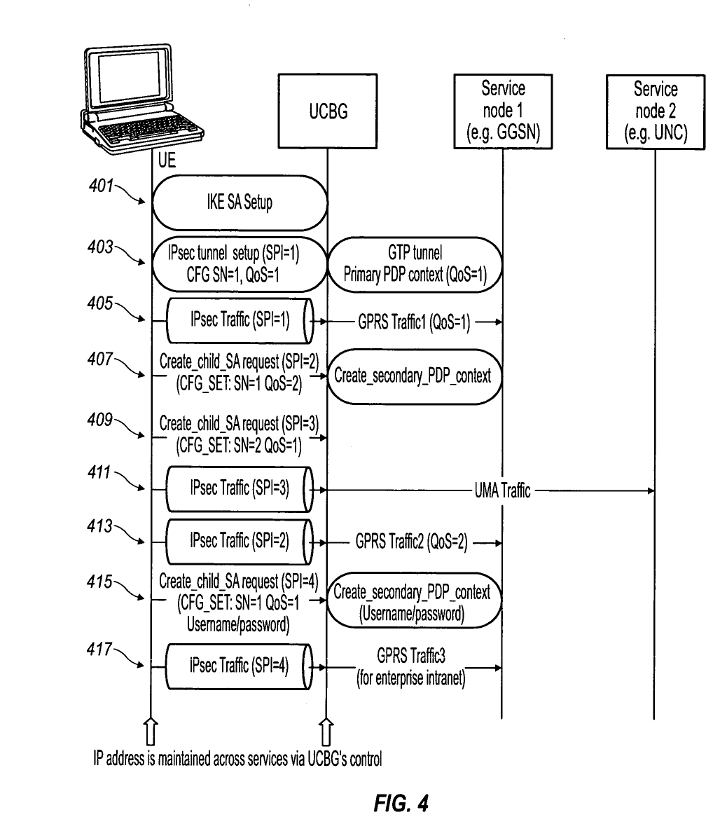

FIG. 4 is a message flow/signaling chart of a sample embodiment of a network architecture incorporating a universal convergence border gateway.

In this figure, an IKE SA is established between the UE and the UCBG (message flow 401). This SA is used for all the services regardless of the services and/or service characteristics, e.g. QoS. All of the control messages are encrypted, and their integrity is protected. A first IPSec SA is established for data transfer. In this example, it is assumed that the service requested by the user needs the GGSN as a service node. A GTP tunnel is then established between the UCBG and the GGSN (message flow 403). For the traffic for this service, the UE would send and receive the data inside IPSec tunnel 1, and the UCBG forwards the message accordingly to the GGSN (message flow 405). If another service with different characteristics, e.g. QoS, is requested toward the same service node, i.e. the GGSN, a second IPSec SA may be established. The new IPSec SA key can be used or not according to the policy. Another GTP tunnel is established to carry the traffic with different Quos, e.g. QoS2 (message flow 407). If another service through different service node, e.g. the UNC, is requested, the UE establishes another IPSec SA (message flow 409). For the UMA traffic, the UE sends this traffic into the appropriate IPSec tunnel. The UCBG identifies the traffic by the SPI and directs the traffic accordingly to the UNC (message flow 411). For the GPRS traffic with different QoS, e.g. QoS2, the UE sends this traffic into the appropriate IPSec tunnel, and the UCBG directs the traffic accordingly to the GGSN (message flow 413). If there is a request to establish the VPN for enterprise, the UE may establish another IPSec tunnel, providing the required username/password information. The UCBG forwards this information and request to the GGSN, creating a GTP tunnel (message flow 415). The enterprise VPN traffic is carried inside the appropriate IPSec tunnel and GTP tunnel to the destination in enterprise intranet (message flow 417).

Enabling New Access Technologies

It is evident that wireless applications are being migrated to IP (packet switched, PS). A common packet service platform would enable mobile operators to easily introduce new services and enhance the existing services.

Furthermore, mobile operators would like to extend their service offerings to all access technologies deployed (e.g. cellular, Wi-Fi, or WiMAX). The disclosed converged gateway platform enables seamless offering of wireless services over any access technologies with secure access to the operator's core service delivery platforms.

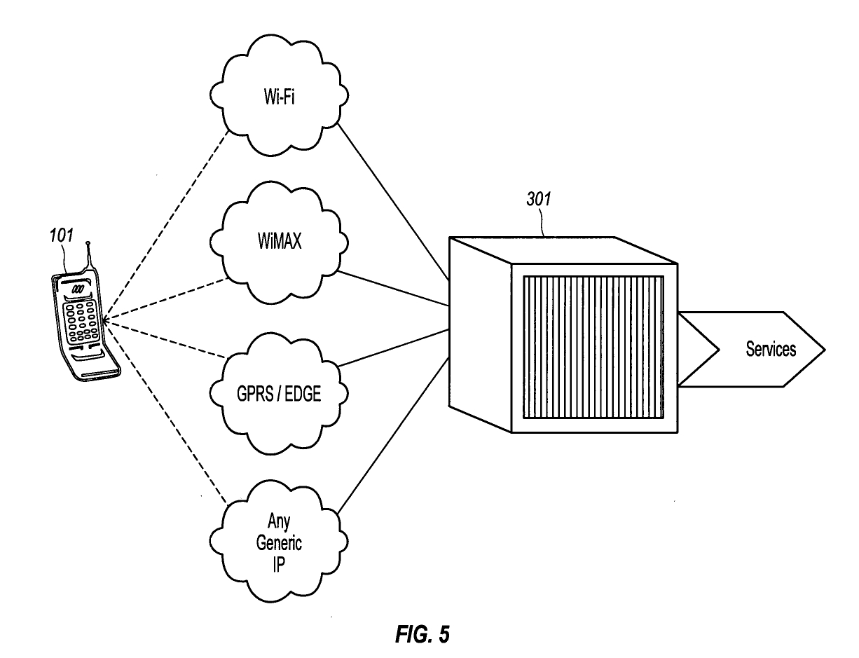

FIG. 5 shows a sample embodiment of a universal convergence border gateway used as an access-independent services gateway.

In this embodiment, user equipment 101 can access all of the services through any access technology, such as Wi-Fi, WiMAX, GPRS/EDGE, and any generic IP. UCBG 301 operates at the IP layer. Therefore, UCBG 301 functions independently of the access network technology. UCBG 301 can be deployed easily at the core network edge to provide secure common service delivery regardless of access technology used by user equipment 101.

This architecture enables mobile operators to utilize the existing 3GPP framework to incorporate new access technologies. One such technology that is receiving a lot of press is WiMAX, which is being drafted by IETF under IEEE 802.16e standardization. By utilizing the same framework as TS 23.234, 3GPP can quickly embrace WiMAX, which can be used to further extend the reach of 3G and IMS.

Using the IP Layer as a Harmonizing Layer

UCBG 301 utilizes the IP layer as a harmonizing layer to decouple standard services from the constraints of their normally-associated access technologies. This is particularly advantageous with multifunction client devices because the best available wireless access technology can be used independently of the type of service being accessed.

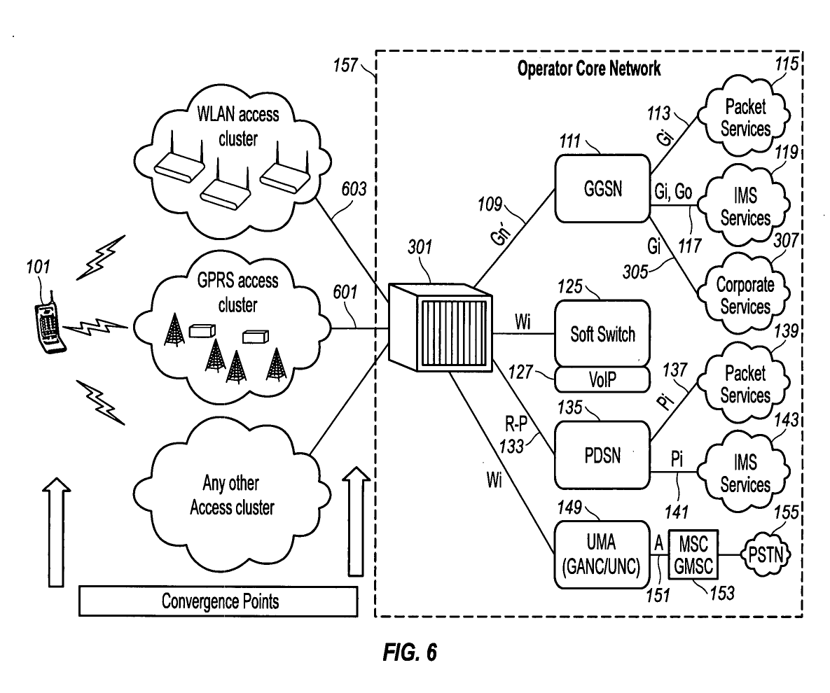

FIG. 6 shows another sample embodiment of a universal convergence border gateway and dual-mode user equipment.

In this embodiment, user equipment 101 is preferably a dual-mode (e.g. WLAN+GPRS) user equipment. Using UCBG 301, the services can be accessed either directly through a GPRS connection 601, or via a WLAN connection 603. In cases where a GPRS access is more suitable, UCBG 301 acts as a GPRS node and enforces user traffic routing directly through GPRS connection 601. In cases where a WLAN access is more suitable, UCBG establishes the secure tunnel over WLAN and enforces the traffic through the WLAN connection. When a particular service (e.g. IMS 119) is offered via an existing node, such as GGSN 111, UCBG 301 establishes a GTP tunnel 109 towards GGSN 111 and switches the user traffic between WLAN connection 603 and GPRS connection 601.

According to a disclosed class of innovative embodiments, there is provided: A method of communicating, comprising the actions of: decoupling standard services from their normally-associated access technologies using the IP layer; and allowing a user equipment to access standard services independently of the access technology normally associated with said services.

According to a disclosed class of innovative embodiments, there is provided: A communication system, comprising: a server which utilizes the IP layer to decouple standard services from their normally-associated access technologies; wherein a user equipment is able to access standard services independently of the access technology normally associated with said services.

According to a disclosed class of innovative embodiments, there is provided: A method for a mobile device to simultaneously communicate with different service nodes, comprising the actions of: using a single primary security association to simultaneously participate in multiple data flows having different traffic characteristics on multiple different types of services; wherein said mobile electronic device uses said single primary security association to manage said multiple different types of services.

According to a disclosed class of innovative embodiments, there is provided: A method of communicating, comprising the actions of: mutiplexing multiple data flows, having different characteristics for multiple different types of services, using a single encryption scheme; and communicating said data flows between a mobile electronic device and a convergence gateway using respective secondary data paths under the management of a single primary control path; wherein said mobile electronic device can simultaneously access services from multiple different types of services, under the management of said single primary control path.

According to a disclosed class of innovative embodiments, there is provided: A communications system, comprising: a mobile electronic device which can simultaneously participate in multiple data flows having different traffic characteristics for multiple different types of services; and multiplexing software which generates said multiple data flows using the configuration of a single primary security association to distinguish said multiple data flows; and allows said mobile electronic device to interface with a convergence gateway through said single primary security association; wherein said mobile electronic device can simultaneously access said multiple different types of services under the control of said single primary security association.

According to a disclosed class of innovative embodiments, there is provided: A system for communication with a mobile client, comprising: a single primary security association between a server and a mobile client; wherein said server uses the payload of said single primary security association to multiplex the traffic for two or more different types of services into two or more data flows; and wherein said server simultaneously delivers services from said two or more different types of services nodes to said mobile client, under the control of said single primary security association.

According to a disclosed class of innovative embodiments, there is provided: A method of delivering network services to a client, comprising the actions of: in a mobile client, running multiple applications which interface to different respective types of data flows, and multiplexing and demultiplexing said data flows in multiple secondary security associations under the control of a single primary security association; and in a gateway server, multiplexing and demultiplexing data flows of multiple different types in multiple secondary security associations, and routing said data flows to the appropriate service nodes; wherein said server simultaneously delivers services from said services nodes to said client independently of the access technology used by said client to access said services.

According to a disclosed class of innovative embodiments, there is provided: A method of delivering network services, comprising the actions of: managing a first data flow between a server and a user equipment to carry traffic of a first characteristic associated with a first service node; if there is traffic of a second characteristic associated with said first service node, managing a second data flow between said server and said user equipment to carry traffic of said second characteristic; and if there is traffic associated with a second service node, managing a third data flow between said server and said user equipment to carry traffic associated with said second service node; wherein the respective services of said first and second service nodes are delivered to said user equipment through the respective data flows and under the control of a single security association between said user equipment and said server; and wherein additional data flows, between said server and said user equipment, are created as needed using said single security association.

According to a disclosed class of innovative embodiments, there is provided: A communication system comprising: a security association between a server and a user equipment; a first data flow between said server and said user equipment, said first data flow is generated from the payload configuration of said security association and carries traffic of a first characteristic associated with a first service node; if there is traffic of a second characteristic associated with said first service node, a second data flow between said server and said user equipment, said second data flow is generated from the payload configuration of said security association and carries traffic of the second characteristic; and if there is traffic associated with a second service node, a third data flow between said server and said user equipment, said third data flow is generated from the payload configuration of said security association and carries traffic associated with said second service node; wherein an end user is able to simultaneously access the services of said first and second service nodes under the control of said security association; and wherein additional data flows, between said server and said user equipment, are created as needed using said security association.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

Although in preferred embodiments IPSec is used to secure and differentiate the traffic, any method of securing and differentiating the traffic can be used.

Although in preferred embodiments IKE is used with IPSec to make up the protocol suite, other encryption standards are, of course, possible. For example, DES, 3DES, D-H, MD5, SHA-1, RSA signatures, AES, and CAs may also be used.

Although in preferred embodiments, IKE is used for key exchange and management for IPsec, other key exchange and management mechanisms are, of course, possible.

The UCBG of the present application may be implemented in any hardware including chassis-based platforms. In case the chassis-based platform is used, the blades in the chassis are divided as clusters to function as either control blades or the data blades. The chassis would provide the high availability so that the active user sessions and the statistics are not lost in case of a blade failure. There will be no single point of failure in UCBG.

Additional general background, which helps to show variations and implementations, may be found in the following publications, all of which are hereby incorporated by reference:
Sumit Kasera & Nishit Narang, 3G Mobile Networks (2005).
Theodore S. Rappaport, Wireless Communications Principles and Practice (2nd ed. 2002).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method of communicating, comprising the actions of:
decoupling standard services from their normally-associated access technologies using the IP layer; and
allowing a user equipment to access standard services independently of the access technology normally associated with said services.

2. A communication system, comprising:
a server which utilizes the IP layer to decouple standard services from their normally-associated access technologies;
wherein a user equipment is able to access standard services independently of the access technology normally associated with said services.

3. A method for a mobile device to simultaneously communicate with different service nodes, comprising the actions of:
using a single primary security association to simultaneously participate in multiple data flows having different traffic characteristics on multiple different types of services;
wherein said mobile electronic device uses said single primary security association to manage said multiple different types of services.

4. The method of claim 3, wherein said multiple data flows are controlled by said single primary security association.

5. The method of claim 3, wherein said single primary security association is an Internet Key Exchange Security Association (IKE SA).

6. The method of claim 5, wherein the information on services is transferred using the configuration payload of said IKE SA.

7. The method of claim 5, wherein the service characteristics are transferred using the configuration payload of said IKE SA.

8. The method of claim 5, wherein a client's username/password information is securely delivered to a service requiring said information using the configuration payload of said IKE SA.

9. The method of claim 3, wherein said multiple data flows are Internet Protocol Security Security Associations (IPSec SAs).

10. The method of claim 9, wherein said multiple data flows are distinguished using their respective Security Parameter Index (SPI) values.

11. A method of communicating, comprising the actions of:
mutiplexing multiple data flows,
having different characteristics for multiple different types of services, using a single encryption scheme; and
communicating said data flows between a mobile electronic device and a convergence gateway
using respective secondary data paths under the management of a single primary control path;
wherein said mobile electronic device can
simultaneously access services from multiple different types of services, under the management of said single primary control path.

12. The method of claim 11, wherein said multiple data flows are multiplexed using a single encryption scheme, where the traffic characteristics of said data flows are not lost during multiplexing.

13. The method of claim 11, wherein said single primary control path is an Internet Key Exchange Security Association (IKE SA).

14. The method of claim 11, wherein said data flows are Internet Protocol Security Security Associations (IPSec SAs).

15. A communications system, comprising:
a mobile electronic device which can simultaneously participate in multiple data flows having different traffic characteristics for multiple different types of services; and
multiplexing software which
generates said multiple data flows
using the configuration of a single primary security association to distinguish said multiple data flows; and
allows said mobile electronic device to interface with a convergence gateway through said single primary security association;
wherein said mobile electronic device can simultaneously access said multiple different types of services under the control of said single primary security association.

16. The system of claim 15, wherein said multiple data flows are controlled by said single primary security association.

17. The system of claim 15, wherein said single primary security association is an Internet Key Exchange Security Association (IKE SA).

18. The system of claim 17, wherein the information on services, including the service characteristics, is transferred using the configuration payload of said IKE SA.

19. The system of claim 17, wherein a client's username/password information is securely delivered to a service requiring said information using the configuration payload of said IKE SA.

20. The system of claim 15, wherein said multiple data flows are Internet Protocol Security Security Associations (IPSec SAs).

21. The system of claim 20, wherein said multiple data flows are distinguished using their respective Security Parameter Index (SPI) values.

22. The system of claim 15, wherein said multiplexing software runs on said mobile electronic device.

23. The system of claim 15, wherein said traffic characteristics of said multiple data flows are not lost during multiplexing.

24. A system for communication with a mobile client, comprising:
a single primary security association between a server and a mobile client;
wherein said server uses the payload of said single primary security association to multiplex the traffic for two or more different types of services into two or more data flows; and
wherein said server
simultaneously delivers services from said two or more different types of services nodes to said mobile client,
under the control of said single primary security association.

25. The system of claim 24, wherein said data flows are controlled by said single primary security association.

26. The system of claim 24, wherein said server multiplexes the traffic from two or more different types of service nodes using a single encryption scheme, where the traffic characteristics of said data flows are not lost during multiplexing.

27. The system of claim 24, wherein said server also demultiplexes the traffic, associated with two or more different types of services, from said mobile client to route said traffic to the appropriate service nodes.

28. The system of claim 24, wherein said server demultiplexes the traffic, associated with two or more different types of service nodes, using Internet Protocol Security Security Parameter Index (IPSec SPI) values.

29. The system of claim 24, wherein said single primary security association is an Internet Key Exchange Security Association (IKE SA).

30. The system of claim 29, wherein a client's username/password information is securely delivered to a service requiring said information using the configuration payload of said IKE SA.

31. The system of claim 24, wherein said data flows are Internet Protocol Security Security Associations (IPSec SAs).

32. A method of delivering network services to a client, comprising the actions of:
in a mobile client,
running multiple applications which interface to different respective types of data flows, and
multiplexing and demultiplexing said data flows in multiple secondary security associations under the control of a single primary security association; and
in a gateway server,
multiplexing and demultiplexing data flows of multiple different types in multiple secondary security associations, and
routing said data flows to the appropriate service nodes;
wherein said server simultaneously delivers services from said services nodes to said client independently of the access technology used by said client to access said services.

33. The method of claim 32, wherein said gateway server multiplexes said data flows using a single encryption scheme, where the traffic characteristics of said data flows are not lost during multiplexing.

34. The method of claim 32, wherein said server demultiplexes said data flows using Internet Protocol Security Security Parameter Index (IPSec SPI) values.

35. The method of claim 32, wherein said single primary security association is an Internet Key Exchange Security Association (IKE SA).

36. The method of claim 35, wherein a client's username/password information is securely delivered to a service requiring said information using the configuration payload of said IKE SA.

37. The method of claim 32, wherein said data flows are Internet Protocol Security Security Associations (IPSec SAs).

38. A method of delivering network services, comprising the actions of:
managing a first data flow between a server and a user equipment to carry traffic of a first characteristic associated with a first service node;
if there is traffic of a second characteristic associated with said first service node, managing a second data flow between said server and said user equipment to carry traffic of said second characteristic; and
if there is traffic associated with a second service node, managing a third data flow between said server and said user equipment to carry traffic associated with said second service node;
wherein the respective services of said first and second service nodes are delivered to said user equipment through the respective data flows and under the control of a single security association between said user equipment and said server; and
wherein additional data flows, between said server and said user equipment, are created as needed using said single security association.

39. The method of claim 38, wherein said single security association is an Internet Key Exchange Security Association (IKE SA).

40. The method of claim 38, wherein said first, second, and third data flows are Internet Protocol Security Security Associations (IPSec SAs).

41. A communication system comprising:
a security association between a server and a user equipment;
a first data flow between said server and said user equipment, said first data flow is generated from the payload configuration of said security association and carries traffic of a first characteristic associated with a first service node;
if there is traffic of a second characteristic associated with said first service node, a second data flow between said server and said user equipment, said second data flow is generated from the payload configuration of said security association and carries traffic of the second characteristic; and
if there is traffic associated with a second service node, a third data flow between said server and said user equipment, said third data flow is generated from the payload configuration of said security association and carries traffic associated with said second service node;
wherein an end user is able to simultaneously access the services of said first and second service nodes under the control of said security association; and
wherein additional data flows, between said server and said user equipment, are created as needed using said security association.

42. The system of claim 41, wherein said first, second, and third data flows are controlled by said security association.

43. The system of claim 41, wherein said server multiplexes said first, second, and third data flows using a single encryption scheme, where the traffic characteristics of said data flows are not lost during multiplexing.

44. The system of claim 41, wherein said server demultiplexes data flows from said end user and sends said data flows to the appropriate service nodes.

45. The system of claim 44, wherein said server demultiplexes said data flows using Internet Protocol Security Security Parameter Index (IPSec SPI) values.

46. The system of claim 41, wherein said security association is an Internet Key Exchange Security Association (IKE SA).

47. The system of claim 41, wherein said data flows are Internet Protocol Security Security Associations (IPSec SAs).
